(19) United States
(12) Patent Application Publication
(10) Pub. No.: US 2004/0108048 A1
(43) Pub. Date: Jun. 10, 2004

(54) Back light type display panel and method of manufacturing same

(76) Inventors: Kiyoshi Nakakuki, Yokkaichi-city (JP); Teruhiko Iwase, Nagoya-city (JP); Takeharu Maekawa, Nagoya-city (JP); Osamu Ina, Anjo-city (JP); Takashi Aoki, Toyoake-city (JP)

Correspondence Address: POSZ & BETHARDS, PLC, 11250 ROGER BACON DRIVE, SUITE 10, RESTON, VA, 20190, US

(21) Appl. No.: 10/716,548

(22) Filed: Nov. 20, 2003

(30) Foreign Application Priority Data
Nov. 22, 2002 (JP) 2002-339244
Dec. 12, 2002 (JP) 2002-361030
Dec. 26, 2002 (JP) 2002-376956

(51) Int. Cl. B44C 1/165; B44C 1/00

(52) U.S. Cl. 156/230; 156/240; 156/241; 428/195.1

(57) ABSTRACT

A method of manufacturing a back light type display panel includes a first step of forming on a transparent base film an opaque area of a thick layer of toner particles and a transparent area of a thin layer of toner particles, a second step of covering the opaque and transparent areas of the base film with a transparent protection film. In this step, a thermoplastic adhesive agent is coated on the protection film to form a laminate member of thick and thin layers of toner and the protection film. The method further includes a third step of vacuuming the laminate member and its surrounding, and a fourth step of heating the laminate member to be lower for the toner to melt and sufficiently high for the adhesive agent to have a characteristic of tack and pressing the laminate member at a first pressure by a pair of pressing boards, and a fifth step of heating the laminate member to be sufficiently high for the toner to melt.

### CROSS REFERENCE TO RELATED APPLICATION

The present application is based on and claims priority from the following Japanese Patent Applications: 2002-339244, filed Nov. 22, 2002; 2002-361030, filed Dec. 12, 2002; and 2002-376956, filed Dec. 26, 2002; the contents of which are incorporated herein by reference.

### BACKGROUND OF THE INVENTION

1. Field of the Invention

The present invention relates to a back light type display panel that is illuminated by a back light and, in particular, a back light type display panel that is applied to an indicating instrument of an automotive vehicle and a method of manufacturing such a display panel.

2. Description of the Related Art

A back light type display panel is usually constituted of a transparent base film on which opaque areas and transparent areas are printed by a screen printer so as to display information or data by transmitting light through the transparent areas from behind the display panel. In order to manufacture a variety of back light type display panels in a small lot by printing various patterns on the base film, an electrophotographic device has been employed, as disclosed in JP-A-2002-156252 and 2002-160549. However, the opaque printed areas printed by such an electrophotographic device does not as sufficiently shield the light as those printed by the screen printer. As a result, the visibility of the back light type display panel that is printed by the electrophotographic device is considerably lower than the visibility of the back light type display panel that is printed by the screen printer.

### SUMMARY OF THE INVENTION

Therefore, it is an object of the invention to provide an improved method of manufacturing a back light type display panel by an electrophotographic device.

According to a feature of the invention, an improved method of manufacturing a back light type display panel is constituted of a first step of forming on a base film an opaque printed area of a thick layer of toner particles and a transparent printed area of a thin layer of toner particles, a second step of covering the opaque and transparent printed areas of the base film with a transparent protection film on which a thermoplastic adhesive agent is coated to form a laminate member of the base film, thick and thin layers of toner particles, the adhesive agent and the protection film, a third step of vacuuming the laminate member and its surrounding, a fourth step of heating the laminate member to be low for the toner particles to melt and sufficiently high for the adhesive agent to have a characteristic of tack or tackiness and pressing opposite surfaces of the laminate member at a first pressure by a pair of pressing boards, and a fifth step of heating the laminate member to be sufficiently high for the toner to melt, thereby fixing the toner to the base film.

Although a gap is formed between the transparent area and the adhesive agent at the third step, the gap is filled with the adhesive agent that has been heated to have a characteristic of tack at the fourth step in which the laminate member is pressed. Since the toner particles are also heated and pressured at the fourth step, voids formed between the toner particles are also decreased at the fourth step. Since the laminate member and its surroundings are vacuumed, air does not remain at the opaque area or transparent area, or between the toner particles.

Since the toner particles are melted after the gap is filled with the adhesive agent at the fourth step, the melted toner of the opaque area is prevented from flowing to the transparent area. This prevents blot of the display.

According to another feature of the invention, a method of manufacturing a back light type indicator includes a first step of forming on a transparent base film an opaque printed area of a thick layer of toner particles, a second step of covering the opaque printed area with a transparent protection film on which a thermoplastic adhesive agent is coated to form a laminate member, a third step of vacuuming the laminate member and its surrounding, a fourth step of heating the laminate member to be lower for the toner particles to melt and sufficiently high for the adhesive agent to have a characteristic of tack or quick stick; and a fifth step of heating the laminate member to be sufficiently high for the toner particles to melt, thereby fixing the toner to the base film.

Thus, an inexpensive back light type display panel can be provided without transparent toner particles.

In the above method, the fourth step may include a step of heating a pressing board to heat the laminate member, the fifth step may include a step of heating the pressing boards to heat the laminate member.

The fifth step may includes a step of heating the pair of pressing boards while pressing the laminate member at a second pressure. The fifth step may further include a step of carrying the laminate member to a heating chamber and a step of blowing heated air over it.

The third step may include a step of inserting the laminate member between the pair of pressing boards, a step of forming a hermetic space by the pressing boards and a step of evacuating air from the hermetic space for vacuuming. The step of evacuating air may be carried out while the laminate member is inserted between the pair of pressing boards.

The step of forming the opaque printed area may include a step of forming a first layer of the toner particles on the base film and a step of forming a second layer of the toner particles on the first layer of the toner. Here, the second layer of the toner particles is formed so that the periphery thereof can be located within the periphery of the first layer of the toner particles.

In the above method the radius of corners of the opaque printed area adjacent to the transparent printed area can be larger than 0.3 mm.

Another object of the invention is to provide an improved back light type display panel. In particular, both the opaque printed area and the transparent printed area can be formed with deep colors without using toner particles of deep color which necessitate an additional photoreceptor drum.

According to the feature of the invention for this object, a back light type display panel includes a transparent base film, an opaque layer of printed toner particles printed on the base film, a transparent layer of ink printed on the base film. In the above combined structure, the opaque layer of printed toner particles and the transparent layer of printed ink are disposed in planes in parallel with the base film to form a display pattern that can be seen through the transparent base film from one side of the base film when the display pattern is illuminated from the other side thereof. Further, the transparent display pattern is defined by a border line between the layer of the toner particles and the layer of the ink.

Accordingly, a desired and beautiful color tone can be provided without using a layer of deep color toner particles.

According to another feature of the invention, a back light type display panel includes a transparent base film, a transparent layer of printed toner particles printed on the base film so that transmission density thereof gradually changes, a transparent layer of color ink printed on the base film. In addition, the transparent layer of printed toner particles and the transparent layer of printed color ink are overlapped in a line of vision to form a mixed color display pattern that can be seen through the transparent base film from one side of the base film when the display pattern is illuminated from the other side thereof.

Accordingly, a smooth and beautiful color gradation can be provided without difficulty.

Further, the transparent layer of toner particles includes a higher perceptive area and a lower perceptive area in transmission density, and the higher perceptive area is made larger than the lower perceptive area. Moreover, the opaque layer of toner particles may include two layers of the first and the second toner particles. The two layers of the first and second toner particles may be different in toner density from each other.

Another object of the invention is to provide an improved back light type display panel that is free from warping.

According to a feature of the invention for this object, a back light type display panel includes a transparent base film, a layer of printed toner particles printed on a rear surface of the base film, a transparent protecting film covering the transparent layer of printed toner particles, and a light conductive plate disposed on the surface of the transparent protecting film away from the layer of printed toner particles. In the above display panel, the protecting film is made of ultraviolet curing epoxy resin whose hardening shrinkage degree of volume is less than 5%, and the light conductive plate is made of one of polycarbonate resin and acrylic resin.

Because the protecting film is made of ultraviolet curing epoxy resin, the protecting film can be formed without heat, so that the layer of the toner particles can be prevented from heat-shrinking. As a result, the display panel can be made flat. The combination of the protecting film that is made of epoxy resin or polycarbonate resin and the light conductive plate that is made of acrylic resin provides a tuck-free connection between the protecting film and the conductive plate.

According to a further feature of the invention, the ultraviolet curing epoxy resin is preferably made of cationic polymer.

According to another feature of the invention, the protecting film may include at least one of beads and fillers as a mixture. Accordingly, the light conductive plate can have point contacts with the beads or fillers, and contact area of the light conductive plate with the protecting film 40 can be reduced, so that the tuck-free connection can be further ensured.

Further, the back light display panel may further include a luster controlling layer disposed on the base film.

### BRIEF DESCRIPTION OF THE DRAWINGS

Other objects, features and characteristics of the present invention as well as the functions of related parts of the present invention will become clear from a study of the following detailed description, the appended claims and the drawings. In the drawings:

FIG. 1 is a front view of a back light type display panel manufactured by a method according to the first embodiment of the invention;

FIG. 2 is a cross-sectional side view of the display panel shown in FIG. 1;

FIG. 3 is a schematic diagram illustrating a manufacturing system of the display panel;

FIG. 4 is a schematic diagram illustrating a step of transcribing toner on a transparent base film;

FIG. 5 is a schematic cross-sectional view illustrating a laminate display panel manufactured by the manufacturing system shown in FIG. 3;

FIG. 6 is a schematic diagram illustrating a secondary photographic fixing device;

FIG. 7 is a schematic diagram illustrating the secondary photographic fixing device illustrated in FIG. 6 at an evacuation step;

FIG. 8 is a graph showing a relationship between temperature of a fixing agent and viscosity thereof;

FIG. 9 is a graph showing a relationship between temperature of a pressing board of the secondary photographic fixing device and heating time;

FIG. 10 is an enlarged schematic front view illustrating a scale mark and a back ground portion of an display panel manufactured by a method according to the second embodiment of the invention;

FIG. 11 is an enlarged schematic front view illustrating a scale mark and a back ground portion of the display panel manufactured by the method according to the second embodiment of the invention;

FIG. 12 is a schematic diagram illustrating a step of transcribing toner on a transparent base film of a method according to the third embodiment of the invention;

FIG. 13 is a schematic diagram illustrating a step of transcribing toner on a transparent base film of a method according to the fourth embodiment of the invention;

FIG. 14 is a cross-sectional side view of the base film illustrated in FIG. 13;

FIG. 15 is a front view of a back light type display panel according to the fifth embodiment of the invention;

FIG. 16 is a cross-sectional side view of the display panel shown in FIG. 15;

FIG. 17A illustrates a layer of toner particles on a base film, and FIG. 17B illustrates a layer of ink on a protection film;

FIG. 18A is a cross-sectional view illustrating a layer of toner particles on the base film at a transcribing step, FIG. 18B is a cross-sectional view illustrating a laminate member before it is heated, and FIG. 18C is a cross-sectional view illustrating the laminate member after it is heated;

FIG. 19 is an enlarged schematic diagram of a layer of the toner particles illustrating various toner densities;

FIGS. 20A and 20B respectively illustrate a layer of toner particles having a higher perceptive printed area and a layer of toner particles having a lower perceptive printed area;

FIG. 21 is a schematic diagram illustrating a screen printer;

FIG. 22 is a graph illustrating a relationship between transmission density and toner density of combined layers of toner particles of the display panel according to the seventh embodiment;

FIG. 23 is a graph illustrating a relationship between transmission density of combined layers of toner particles of the display panel according to the seventh embodiment and toner density;

FIG. 24 is a graph illustrating a relationship between transmission density of combined layers of toner particles of the display panel according to the eighth embodiment and toner density;

FIG. 25 is a schematic diagram illustrating combined layers of ink of a display panel according to the ninth embodiment;

FIG. 26 is a schematic side view of a laminate member according to the tenth embodiment of the invention;

FIG. 27 is a cross-sectional side view of a display panel according to the twelfth embodiment of the invention;

FIG. 28 is a graph showing a relationship between an amount of warp and a degree of shrinking;

FIG. 29 is a schematic diagram illustrating a test from which the graph shown in FIG. 28 was provided; and

FIG. 30 is a crsoo-sectional side view of a display panel according to the thirteenth embodiment of the invention.

### DETAILED DESCRIPTION OF THE PREFERRED EMBODIMENTS

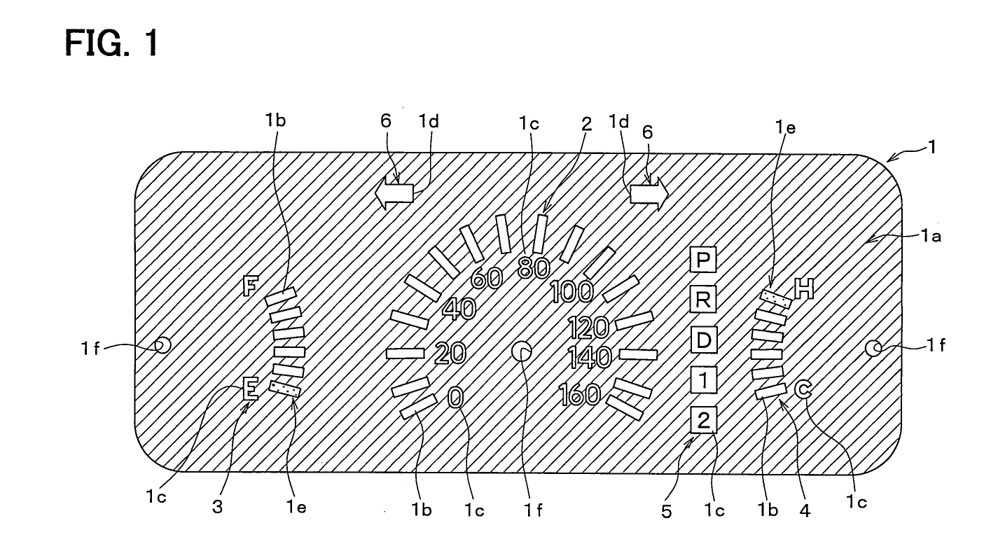

A method of manufacturing a back light type display panel according to the first embodiment of the invention will be described with reference to FIGS. 1-9.

In FIG. 1, a display panel 1 has a a plurality of display sections 2, 3, 4, 5 and 6. The display section 2 indicates a vehicle speed, the display section e indicates a remaining amount of fuel, the display section 4 indicates an engine coolant temperature, the display section 5 indicates a position of a gear shift lever, and the display section 6 indicates a direction signal of a direction indicator.

The display panel 1 is a back light type display panel having a light source disposed at the back thereof. The display panel 1 is constituted of a light shielding background portion 1a (hatched portion), light conducting scale marks 1b, letters 1c, symbols 1d (white or open portions) and scale marks 1e (screened portion), which are disposed at the background portion 1a to form the respective display sections 2-6. The white symbols 1d illuminate in white color. On the other hand, the screened symbols illuminate in red. The background portion is colored with black.

The display sections 2, 3 and 4 respectively has through holes if from which rotary shafts for pointers respectively protrude.

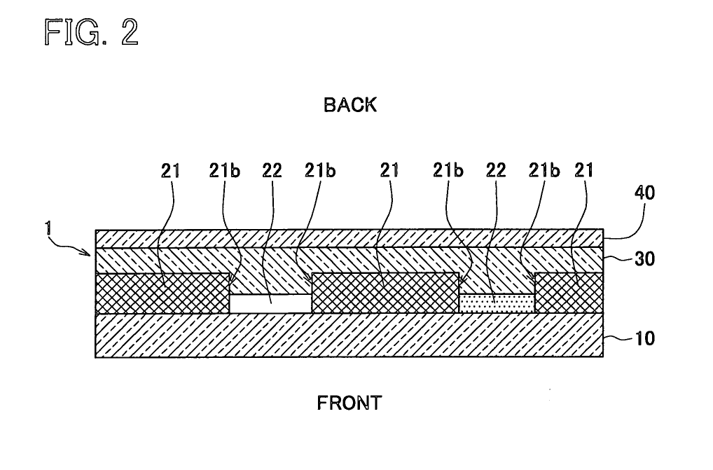

As shown in FIG. 2, the display panel 1 is constituted of a transparent base film 10, opaque printed areas 21 on which thick layers of toner particles k1, k2 are printed, transparent printed areas 22 on which thin layers of toner particles W, R are printed, a layer of transparent adhesive agent 30 and a transparent protection film 40 which shields the printed areas 21, 22.

The printed areas 21, 22 are formed on the back of the base film 10 by an electrophotographic device. That is, display images are reversely printed on the back of the base film 10 so that a driver can see normal display images through the base film 10. The opaque printed areas 21 form the back ground portion 1a, and the transparent printed areas 22 form the scale marks, letters and symbols 1b, 1c, 1d.

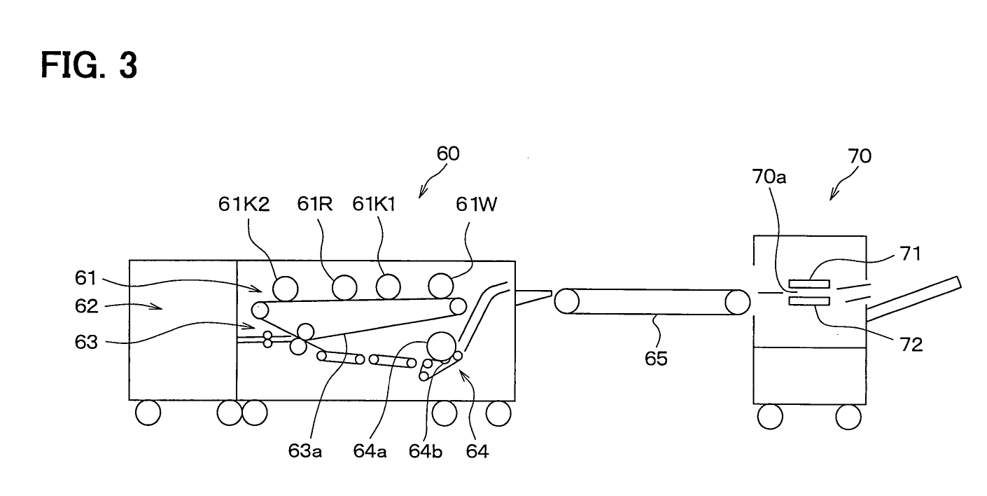

As shown in FIG. 3, a manufacturing system for the display panel 1 includes a primary fixing device 60 and a secondary fixing device 70. The primary fixing device 60 temporarily fixes the layers of toner particles k1, k2, W, R to the base film 10 by an electrophotographic device. The secondary fixing device 70 melts the layers of the toner particles k1, k2, W, R to form a continuous layer and permanently fixes it to the base film 10. The secondary fixing device 70 also functions as a laminating device which covers the printed surface of the base film 10 with a protection film 40. The protection film 40 is pasted to the base film 10 by an adhesive agent 30.

The primary fixing device 60 is constituted of a toner pattern forming section 61 which forms various toner patterns of various colors, a base film feeder section 62, a toner pattern transcribing section 63 and a primary toner fixing section 64. The toner pattern forming section 61 includes photoreceptor drums 61W, 61K1, 61R and 61K2 which respectively form toner patterns of white color (W), black color (K1), red color (R) and black color (K2). Each photoreceptor drum is rotated and electrized by an electrostatic charger, and laser beams are scanned on the surface of the drum to form an electrostatic latent image based on a prescribed image signal. Then, a toner pattern of a color that corresponds to the prescribed image signal is formed on each drum.

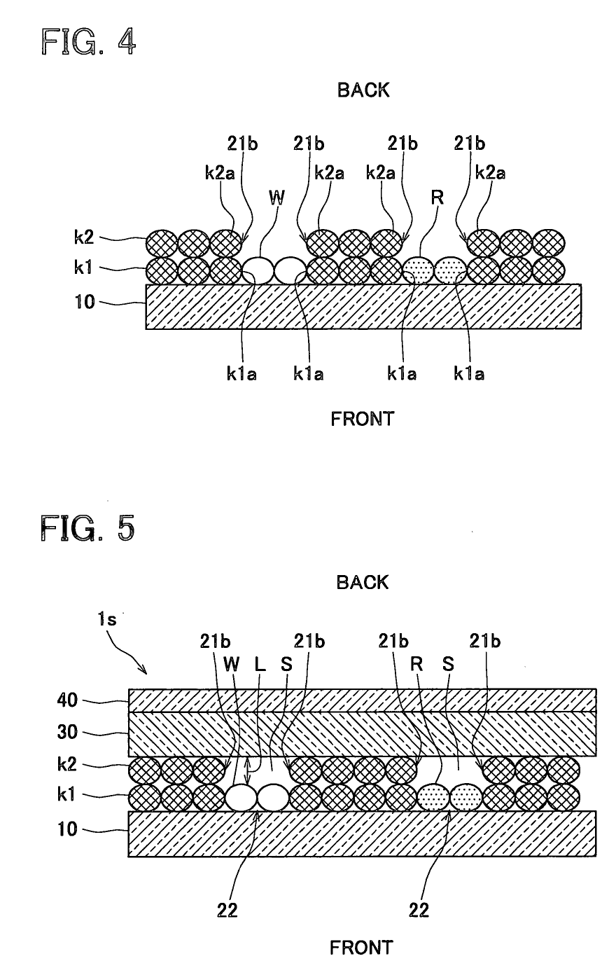

The toner particles k1, k2 are separately transcribed by respective drums 51K1 and 51K2 because much black toner particles k1, k2 have to be transcribed and fixed to the base film 10 to form the opaque printed areas 21. As shown in FIG. 4, the first black toner particles k1 and the second black toner particles k2 are transcribed to the base film 10 in double layers. Thus, insufficient transmission density can be prevented, and the number of pin halls in the background portion 1a can be reduced when a full-color transcription is carried out by the electrophotographic device with three primary colors—cyan, magenta and yellow—and black.

The red toner particles R and the white toner particles W are transcribed in a single layer while the toner particles k1 and k2 are transcribed in two layers. As a result, a step portion is formed between the opaque printed area and the transparent printed area 22. In other words, the transparent printed areas 22 are caved in the opaque printed areas 21 on the base film 10.

The primary fixing device 60 temporarily fixes the toner pattern that is transcribed to the base film 10 when it is pressed between the heat drum 54a and a pressing pad 54b. The surface temperature of the heat drum 54a is set to a lowest temperature T1° that is necessary for the toner particles k1, k2, W and R to adhere to the base film 10 without reducing the transferring speed of the base film 10. The base film 10 to which the toner particles k1, k2, W, R are temporarily fixed is transferred to the secondary fixing device 70. Here, the protection film 40 with a thermoplastic adhesive agent thereon is laid on the printed areas 21, 22 of the base film 10 to form a laminate member is (unfinished display panel), as shown in FIG. 5.

Incidentally, the base film 10 is a transparent and heat resistant member made of PET (polyethylene terephthalate). The base film 10 has a thickness between 75 μm and 500 μm, more preferably between 100 μm and 125 μm. The base film 10 may be made of PVC (polyvinyl chloride), PEN (polyethylene naphthalate), PC (polycarbonate) or the like. The protection film 40 is a transparent and heat resistant member made of PET or the same material as the base film 10. The protection film 40 has a thickness of 50 μm. However, the thickness may be between 18 μm and 350 μm. Since the protection film 40 and the base film 10 are made of the same material, the display panel 1 is prevented from warping, winding or undulating.

The adhesive agent 30 is made of a thermoplastic material such as olefin, acrylic resin, polyurethane, polyester or the like. The adhesive agent 30 has a viscosity between 1×10⁷ and 10³ Pa.s.

The back surface of the base film 10 is surface-treated so that the toner particles k1, k2, W, R can be well fixed to it. For example, the back surface is coated with a layer of charge tunable material, such as polyesher, of several μm thickness.

At this secondary fixing stage, the permanently fixed black toner particles k1, k2 form the background portion 1a, and the permanently fixed white toner particles W form the white scale marks, letters or symbols 1b-1d, and the permanently fixed red toner particles R form the red scale marks (screened portions in FIG. 1).

Each of the toner particles k1, k2, W, R is composed of binding material and color pigment. The binding material may be a homopolymer selected from a group which includesstyrenes, monoolefins, vinylesters, α-methylene aliphatic carboxylic acid esters, vinyl esters, vinyl ketones, etc. or a composite of the above-listed materials.

In particular, the binding material may be selected from homopolymers which include polystyrene, polyethylene or polypropylene, or copolymers which include styrene-acrylic acid ester, styrene-methacrylic acid, styrene-butadiene and styrene-maleic anhydride. Further, the binding material may be polyester,polyurethane, epoxy resin, silicone resin, polyamide, modified rosin, paraffin, or wax. It has been found that polyester is the best for the binding material.

The black toner particles k1, k2 are made of carbon black, the white toner particles W are made of titanium oxide, silica, tin oxide, alumina or magnesia. Titanium oxide is found to be more preferable in view of color fastness to light.

The scale marks, letters or symbols 1b-1d are required to be transparent, and the background portions are required to be concealed. For this purpose, density of the color pigments contained in the color toners and the toner mass per area (TMA) of the plastic film are controlled. For example, the transmission density T of the scale marks, letters and symbols 1b-1d is controlled to be a value between 0.1 and 1.0, or more preferably between 0.3 and 0.7. Accordingly, the content of the color pigments contained in the toner particles W and R is between 4 wt % and 40 wt %, or more preferably between 6 wt % and 35 wt %. TMA of the plastic film is between 0.3 mg/cm² and 1.0 mg/cm².

On the other hand , the transmission density T of the background portion 1a is 3.0 or larger than 3.0. For this purpose, the content of carbon black is a value between 4 wt % and 15 wt %, and TMA of the toner particles k1, k2 is between 1 mg/cm² and 2 mg/cm². If TMA of the black toner particles is increased to be more than 15 wt % by adding carbon black, the electric resistance of the color toner lowers, so that the electrification of the color toner decreases. As a result, color blushing or spattering of toner may arise.

An electric charge control material or wax may be added to the toner particles k1, k2, W, R. The charge control material may be a metal complex of azo group, a metal complex of salicylic acid or alkyl-salicylic acid or a metallic salt. The wax may be a material of olefins such as low molecular weight polyethylene or low molecular weight polypropylene, plant wax such as carnauba wax, animal wax or mineral wax. A preferable mean value of the diameters of the toner particles k1, k2, W, R is between 30 μm and 40 μm. A plasticizer may be added to the toner particles k1, k2, W, R. The plasticizer may be silica, titan oxide, alumina or the like.

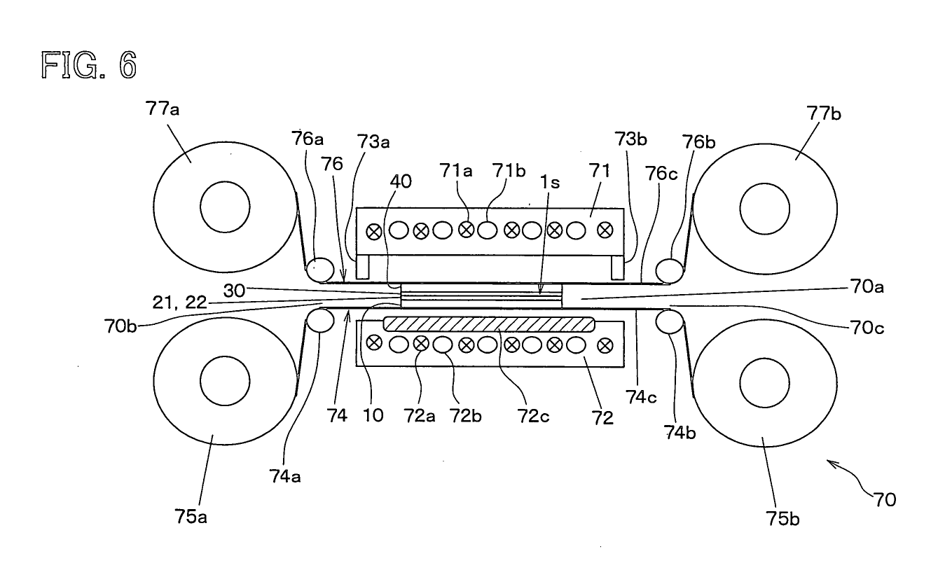

As shown in FIG. 6, the secondary fixing device 70 includes a pair of an upper pressing board 71 and a lower pressing board 72. The secondary fixing device has a function to depressurize a working space between the upper pressing board 71 and the lower pressing board 72 in which the laminate member 1s is accommodated, a function to pressurize the laminate member is at opposite surfaces, a function to heat the laminate member 1s and a function to cool the laminate member 1s.

The upper pressing board 71 and the lower pressing board 72 are disposed in parallel with each other to be movable in directions perpendicular to the boards 71, 72 to change the distance between two. The laminate member is 1s pressed by the pair of boards 71, 72. A pair of rubber packing members 73a, 73 bis disposed at opposite ends of the upper board 73b to vertically project from the inner surface of the upper pressing board 71 toward the inner surface of the lower pressing board 72 to close the working space 70a between the pair of boards 71, 72 when the pair of the pressing boards 73a 73b comes closer. The packing members 73a, 73b elastically deform when they close the working space 70a. The secondary fixing device 70 further includes a function to exhaust air from the working space 70a when the working space is closed, electric heaters 71a, 72a for heating the laminate member 1s, cooling water pipes 71b, 72b for cooling the laminate member 1s, an air bag 72c, a conveyor belt unit 74 and a holding belt unit 76. The heaters 71a, 72a and the pipes 71b, 72b are respectively buried in the pressing boards 71, 72. The air bag 71c is disposed on the upper surface of the lower pressing board 72 to press the the laminate member is uniformly. Accordingly, the laminate member 1s can be heated uniformly. The air bag 71c is inflated by an air pump (not shown) when the laminate member 1s is carried into the working space 70a.

The conveyor belt unit 74 carries the laminate member is through the working space 70a. The conveyor belt unit 74 includes a pair of tension rollers 74a, 74b which are disposed at opposite ends of the secondary fixing device 70, a conveyor belt 74c which is strung across the tension rollers 74a, 74b, a driving roller 75a, and a winding roller 75b. The conveyor belt 74c is driven by the driving roller 75a to pass the pair of tension rollers 74a, 74b and wound by the winding roller 75b.

The holding belt unit 76 holds the laminate member is, which is carried by the conveyor belt 74c, at the upper surface thereof. The holding belt unit includes a pair of tension rollers 76a, 76b which are disposed at opposite ends of the secondary fixing device 70, a holding belt 76c which is strung across the tension rollers 76a, 76b a driving roller 77a and a winding roller 77b. The holding belt 76c is driven by the driving roller 77a to pass the pair of tension rollers 76a, 76b and wound by the winding roller 77b.

The winding rollers 75b, 77b are rotated by a motor (not shown) and synchronously wind the belts 74c, 76c by an equal length. Accordingly, the conveyor belt 74c and the holding belt 76c move in parallel as a unit, so that the laminate member is can be held in position.

A process of manufacturing the display panel 1 according to the first embodiment of the invention will be described below.

(First Step)

At first, the black toner particles k1, k2, the white toner particles W and the red toner particles R are transcribed to the base film 10 by the toner pattern forming section 51, the film feeder section 52 and the toner pattern transcribing section 53. The transcribed toner particles k1, k2, W, R are temporarily fixed to the base film by the primary toner fixing section 54.

(Second step)

While the base film 10 is being carried from the primary fixing device 60 to the secondary fixing device 70 by the conveyor belt unit 55, the protection film 40 coated with the adhesive agent 30 is laid on the printed areas 21, 22 to form the laminate member is that includes the base film 10, a layer of toner particles k1, k2, W, R, a layer of the adhesive agent 30 and the protection film 40, which are disposed in that order, as shown in FIG. 5. The distance L of the gaps S between the toner particles W and the adhesive agent 30 may be longer than 10 μm.

(Third step)

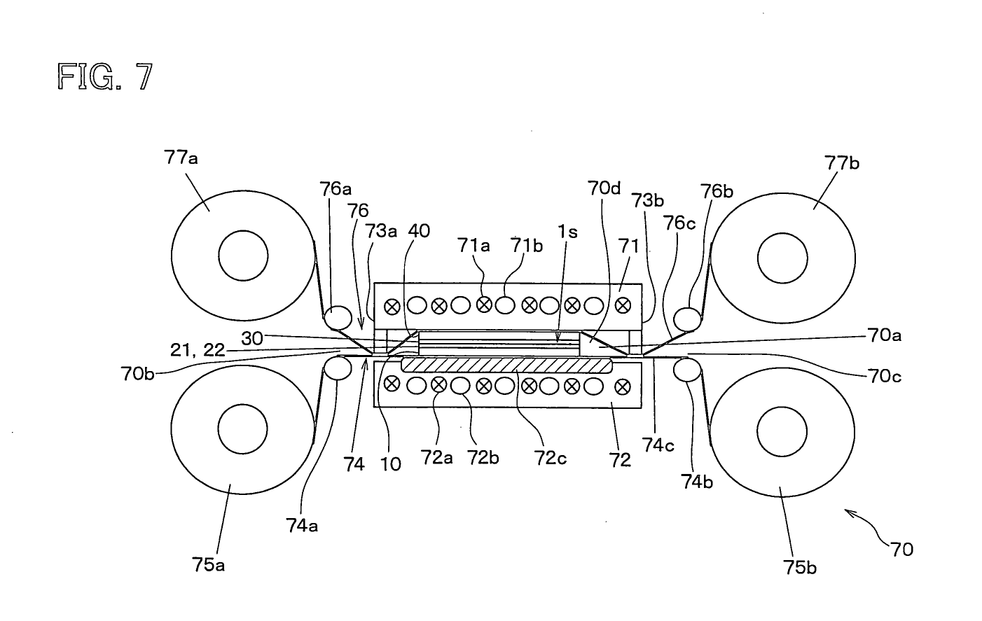

Then, the laminate member is, which is held between the conveyor belt 74c and the holding belt 76c, is carried into the working space 70a and vacuumed, as shown in FIG. 7. At this step, the upper pressing board 71 is moved down to form a hermetic space 70d between the belts 74c and 76c, as well as to hold the laminate member is between the pressing boards 71 and 72. Then, air is expelled from the hermetic space 70d by a pump to decrease the pressure of the hermetic space 70d to a value lower than 3 Torr, or, more preferably, 1 Torr. Since the laminate member 1s is held by the pressing boards 71, 72, the basic film 10 and the protection film 40 can be held in position during the vacuuming.

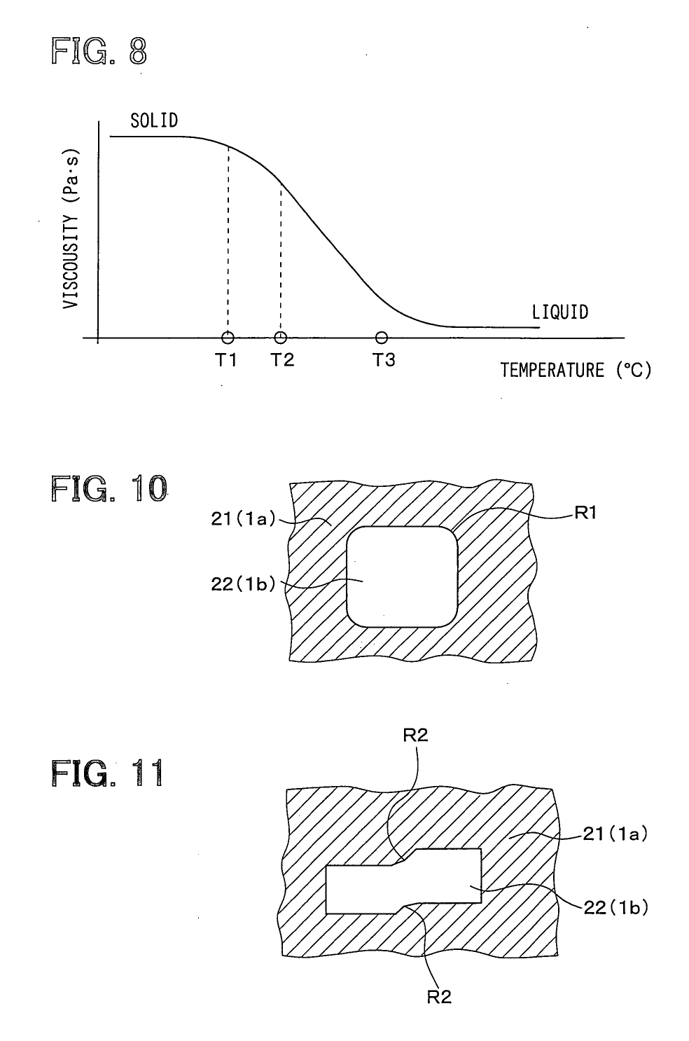

If the adhesive agent is further heated to increase the temperature thereof to T1, it is having a characteristic of tack or tackiness, as shown in FIG. 8. The adhesive agent melts at temperature T2 and becomes liquid at temperature T3 if it is further heated. On the other hand, the toner particles k1, k2, W, R melt at temperature T3, which is higher than temperature T2 at which the adhesive agent 30 melts.

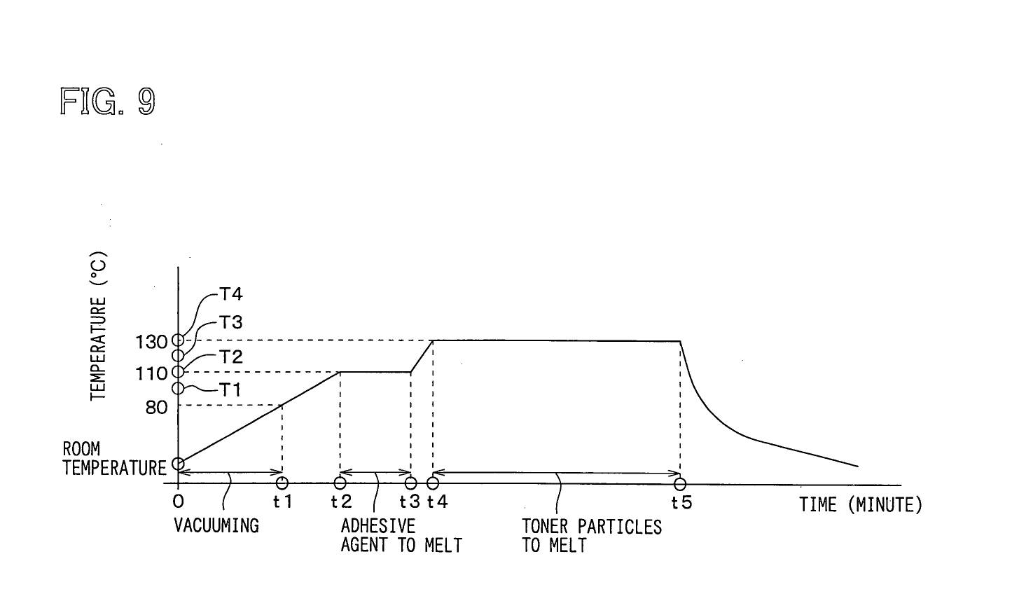

As shown in FIG. 9, the pressing boards 71, 72 are heated by the heaters 71a, 72a when the third step starts. The temperature of the pressing boards 71, 72 is controlled to be less than the temperature T1 at which the characteristic of tack appears in the adhesive agent 30. The vacuuming is continued for a period 0-t1. Accordingly, air does not remain in the gaps between the toner particles k1, k2, W, R. At time t1, the temperature of the pressing boards 71, 72 becomes as high as 80° C., which is lower than the temperature T1.

(Fourth Step)

The pressing boards 71, 72 are further heated until the temperature thereof becomes about the temperature T2. The laminate member 1s is held between the upper pressing board 71 and the inflated air bag 72c and is pressurized at a first pressure, e.g. between 0.05 MPa and 10 MPa. The pressing force is between 1-10 N. This prevents the laminate member 1a from warping.

Although gaps S are formed between the adhesive agent 30 and the transparent printed area 22 at the third step as shown in FIG. 5, the gaps S are filled with the melted adhesive agent 30 at the fourth step. Since the toner particles k1, k2, W, R are also heated and pressurized, they are flattened to thereby eliminate gaps between the toner particles. The toner particles k1, k2, W, R are heated at temperature T2 (e.g. 110° C.) under the prescribed pressure for a period t2-t3 to form a complete laminate member. The period is between 10 seconds and 3 minutes, or, more preferably, 1 minute.

(Fifth Step)

The pressing boards 71, 72 are further heated for a period t4-t5 until the temperature thereof becomes as high as temperature T4 (e.g. about 130° C.) which is higher than the temperature T3 at which the toner particles k1, k2, W, R melt. The laminate member is, which is held between the upper pressing board 71 and the air bag 72c, is pressured at a second pressure (e.g. between 0.05 Mpa and 3 Mpa).

Those of the toner particles k1, k2, W, R that have not melted yet at the third step completely melt and form a continuous layer that is permanently fixed to the base film 10. The period t4-t5 is between 5 minutes and 60 minutes, more preferably, 15 minutes and 30 minutes. The toner particles k1, k2, W, R are prevented by the adhesive agent from flowing away so that the boundaries between the opaque printed area 21 and the transparent printed area 22 can be kept clear.

(Sixth Step)

Thereafter, the pressing boards 71, 72 are cooled with cooling water via the cooling water pipes 71b, 72b while the laminate member is is held between the upper pressing board 71 and the air bag 72c under a third pressure (e.g. a pressure between 0.05 Mpa and 3 Mpa). Thus, a warp-less flat display panel can be formed.

Thereafter, the finished laminate member is or a display panel is carried by the belts 74c, 76c and unloaded from the secondary fixing device 70. Incidentally, the belts 74c, 76c are thin enough (a half as thick as the laminate member is) to conduct heat between the laminate member 1s and the pressing boards 71, 72.

A method of manufacturing a back light type display panel according to the second embodiment will be briefly described with reference to FIGS. 10 and 11. Incidentally, the same reference numeral indicates the same or substantially the same portion, part or component hereafter.

In this embodiment, the radius of corners R1 and R2 of the opaque printed area 21 adjacent to the transparent printed area 22 is larger than 0.3 mm. This prevents sticking of air bubbles to the corners.

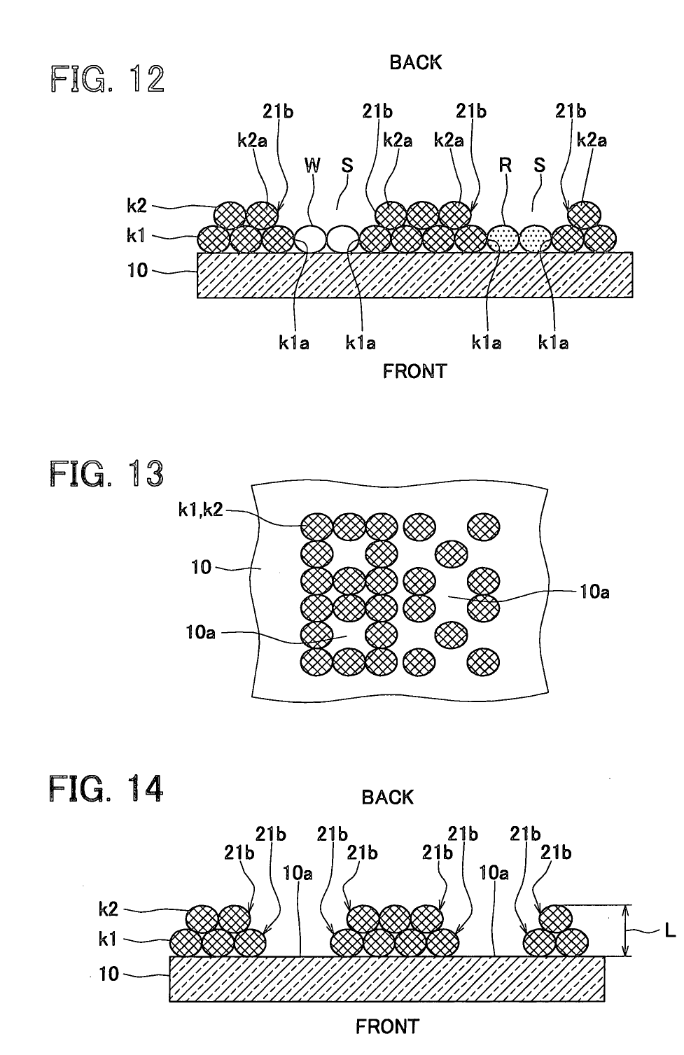

A method of manufacturing a back light type display panel according to the third embodiment of the invention will be briefly described with reference to FIG. 12.

The opaque printed area is formed so that periphery k2a of the layer of toner particles k2 can be located within the periphery k1a of the layer of the toner particles k1. Accordingly, walls 21b of the layer of the opaque printed area 21 that surround the gap S have a gradually inclining slope or step, so that sticking of air bubbles to the walls 21b can be prevented. That is, air is prevented from remaining in the gap S at the vacuuming step.

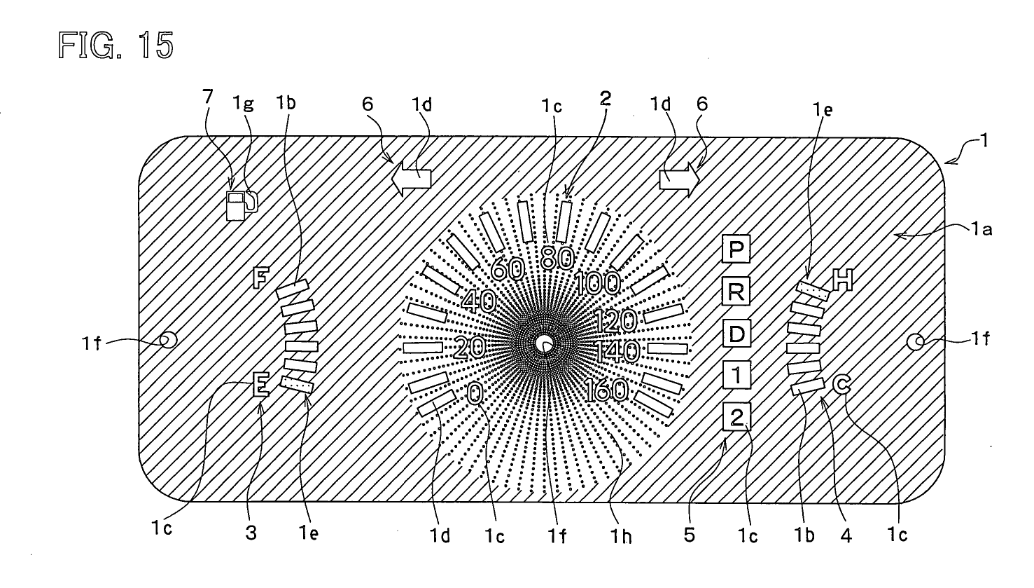

A method of manufacturing a back light type display panel according to the fourth embodiment of the invention will be briefly described with reference to FIGS. 13 and 14.

Instead of the transparent printed area 22 formed by toner particles W and R, portions 10a of the transparent basic film 10 surrounded by the dot-printed toner particles k1, k2 are formed to indicate the white scale marks, letters or symbols 1b-1d. This method can reduce the production cost.

As a modification of the first embodiment, the temperature increase speed of the pressing boards 71, 72 is controlled to be slower than the temperature increase speed of the first embodiment so that the temperature increase continues for the period 0-t3. As a result, the fourth and fifth steps can be carried out continuously. This can reduce time t3-t4 of waiting for the temperature increase shown in FIG. 9.

Because the time of heating at the fifth step is much longer than work speed of the other steps, it may be separated from the other steps in order to adjust work speed or to eliminate a bottle neck of the production speed. If the heater for heating the toner particles k1, k2, W and R at the fifth step is separated from the secondary fixing device 70, it is possible to heat a plurality of laminate members is at the same time.

The vacuuming at the third step can be continued in the subsequent fourth and fifth steps to prevent residual air bubbles.

Next will be described some back light type display panels according to various preferred embodiments of the invention. Incidentally, the same reference numeral appearing hereafter in the drawings corresponds to the same or substantially the same part, portion or component.

A display panel 1 to be mounted in a vehicle according to the fifth embodiment of the invention will be described with reference to FIGS. 15-21.

The display panel 1 is almost the same as the display panel 1 according to the first embodiment of the invention except for a display section 7 for alarming and a round gradated background portion 1h, as shown in FIG. 15.

The round gradated background portion 1h is colored with blue so that the density of the blue color gradually increases toward the center thereof. The transmission density of the background portion is larger than 3.0. On the other hand, the transmission density of the scale marks, letters and symbols 1b-1d is controlled to be a value between 0 and 3.0. The transmission density of the gradated background portion 1h is between 0.0 and 4.0.

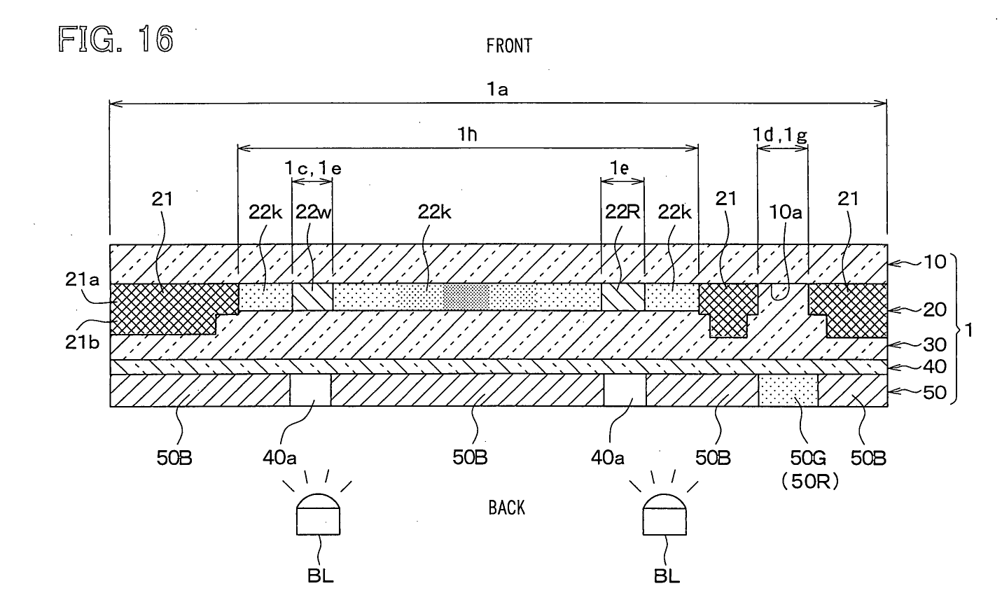

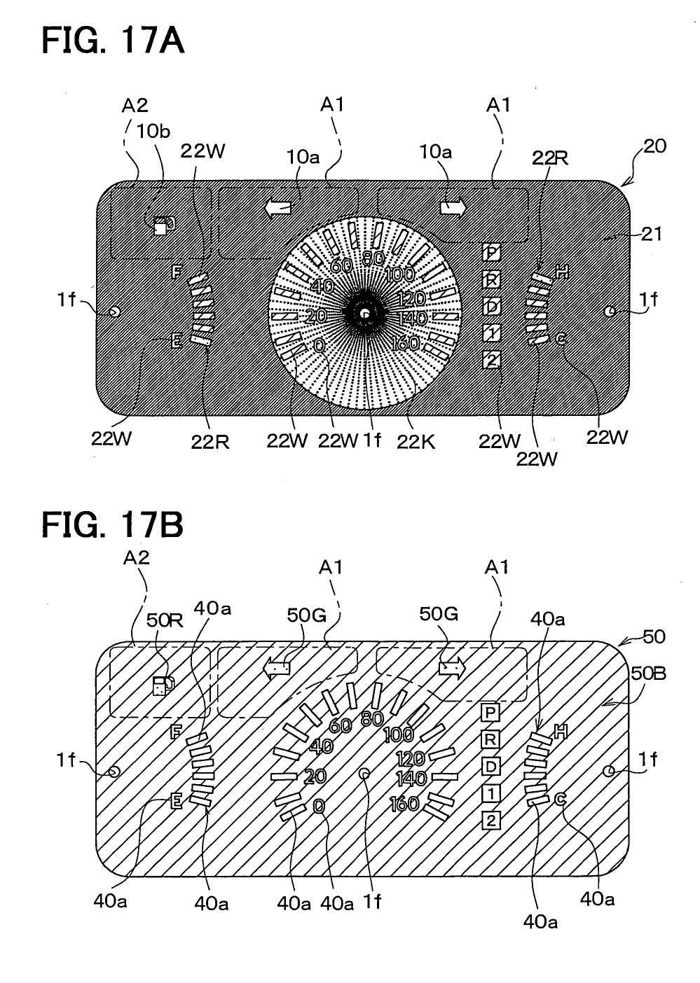

As shown in FIG. 16, the display panel 1 is constituted of a transparent base film 10, a layer 20 of toner particles, a layer of transparent adhesive agent 30, a transparent protection film 40 and a layer 50 of ink in this order from the front surface thereof. The layer 20 of toner particles is constituted of thick printed areas 21 of the toner particles k1, k2 and thin printed areas 22w, 22R, 22k of toner particles W, R and k (transparent thin black). As shown in FIG. 17A, the thin printed area 22k forms the gradated portion 1h. No toner particles is printed on white portions 10a and 10b. The transparent printed areas 22W, 22R, 22k and the opaque printed areas 21 are disposed to be adjacent to each other on or in parallel with the basic film 10. The layer 50 of ink is printed on the back of the protection film 40 by means of a silk-screen printmaking process or the like. The layer 50 is constituted of a plurality of color ink areas: the first ink area 50B of blue ink (trade mark “EG blue”), the second ink area 50G of green ink and the third ink area 50R of red ink, as shown in FIGS. 16 and 17B. Reference numeral 40a indicates a transparent colorless portion of the protection film 40 on which no ink is printed. The layer 20 of the toner particles and the layer 50 of the ink are formed to overlap each other so as to build up prescribed printed patterns as shown in FIG. 15. The gradated background portion 1h of the display section 2 is backed with a dark blue overlap of the transparent printed area 22k and the first ink area 50B, the transmission density of which is about 1.2. The scale marks 1b of display sections 2, 3, 4 and 5 are colored white to provide the transmission density of about 0.4 by the transparent printed area 22W. The scale marks 1e of the display sections 3 and 4 are colored deep red to provide the transmission density of about 0.9 by the transparent printed area 22R. The symbol 1d of the display section 6 is colored deep green to provide the transmission density of about 1.4 by the second ink area 50G. A symbol mark 1g of the display section 7 is colored deep red to provide the transmission density of about 0.9 by the third ink area 50R.

Thus, the gradated background portion 1h and the symbol marks 1d, 1g are clearly defined by the border line between the layer 20 of the toner particles and the layer 50 of the ink. In addition, the gradated background portion 1h and the symbol marks 1d, 1g can be colored by the layer 50 of ink. A thin slit of about 0.1 mm may be formed in a layer of toner particles so that a layer of ink may be laid in the slit. This can provide a thin and clear cut line of ink layer.

A method of manufacturing the above display panel is substantially the same as the method according to the first embodiment, and, therefore, only a brief description will be presented hereafter.

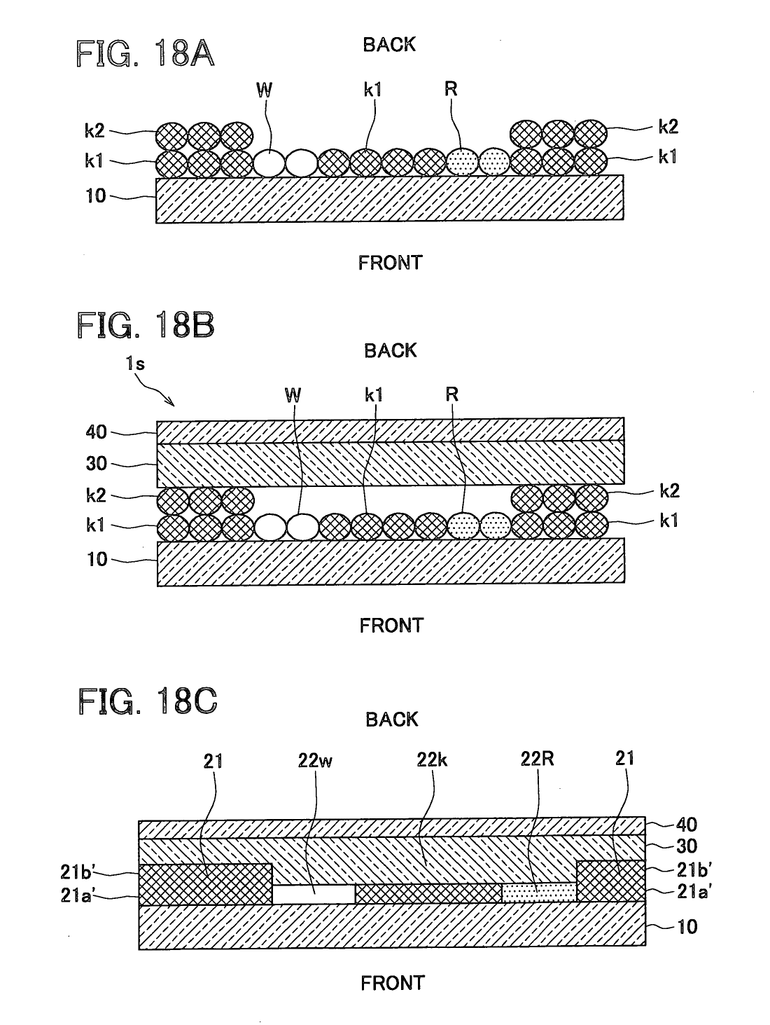

The toner particles k1, k2 are separately transcribed by respective drums 51K1 and 51K2 because much black toner particles k1, k2 have to be transcribed and fixed to the base film 10 to form the opaque printed areas 21. As shown in FIG. 18A, the first black toner particles k1 and the second black toner particles k2 are transcribed to the base film 10 in double layers. The base film 10 to which the toner particles k1, k2, W, R are temporarily fixed is transferred to the secondary fixing device 70, as shown in FIG. 6. Meanwhile, the protection film 40 with a thermoplastic adhesive agent thereon is coated on the printed areas 21, 22 of the base film 10 to form a laminate member 1s, as shown in FIG. 18B.

As shown in FIG. 18C, the toner particles k1, k2 W, R are heated for a prescribed time period to form a complete film fixed to the base film. Thereafter, the laminate member 1s is cooled to prevent warping. Reference numeral 21a′ indicates a layer of the first toner particles k1, and reference numeral 21b′ indicates a layer of the second toner particles k2. The opaque printed area 21 is constituted of two layers of the first and the second toner particles k1, k2, and the transparent printed area 22 is constituted of only a single layer of the first toner particles k1.

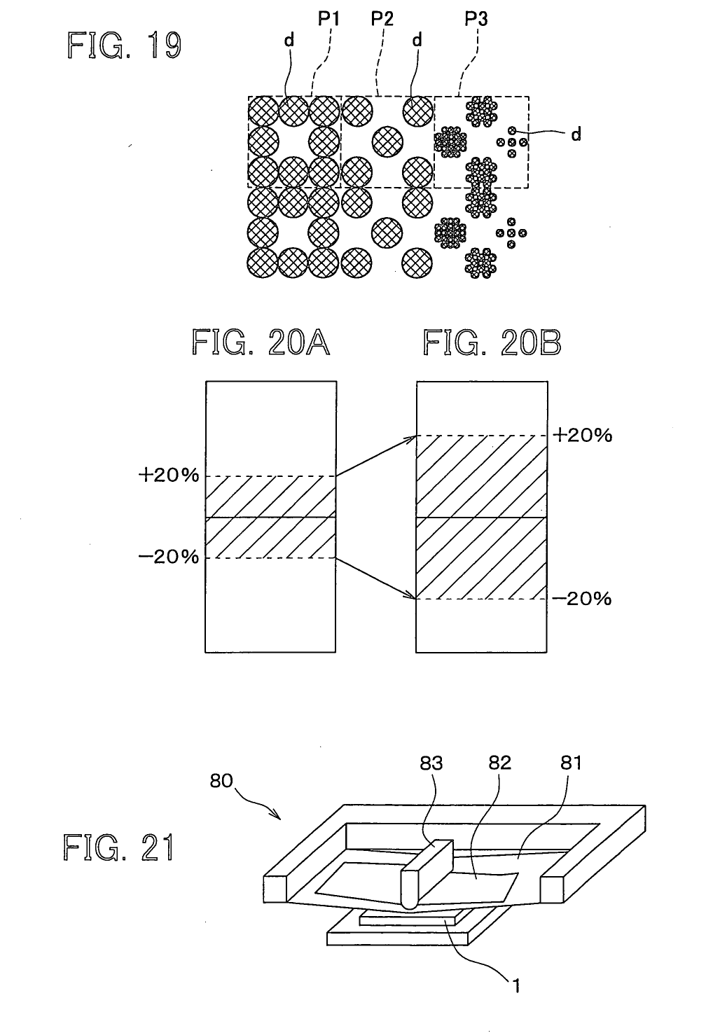

The gradated background portion 1h is constituted of a plurality of different dotted areas P1, P2 and P3, as shown in FIG. 19. The number of dots of the second dotted area P2 is smaller than the first dotted area P1, and the size of the dots of the third dotted area P3 is smaller than the first and second dotted areas P1, P2 so that the transmission density decreases as the dotted area shifts from left to right. It is desirable to change the transmission density by changing the ratio of the dotted area to the white area from 0% to 100%.

Incidentally, there are a higher perceptive area and a lower perceptive area in the transmission density. As shown in FIGS. 20A and 20B, the higher perceptive area (e.g. +20% from the middle (0%) of the transmission density) is made larger than the lower perceptive area in order to make the display panel more attractive.

After the back light type display panel 1 is processed by the secondary fixing device 70, A layer of ink 50 is printed on the back of the protecting film 40 by a screen printer 80 which is shown in FIG. 21. That is, an ink layer 82 is laid on a silk screen 81 or the like and squeezed by a squeeze 83. The transmission density of the ink is between 0.7 and 2.3 and more preferably between 0.9 and 2.0. The resolution of the layer of ink 50 depends on the size of the screen mesh. Usually, the resolution by screen printing is one quarter of the resolution by toner printing.

Because the layer of ink 50 is added to the layer of the toner particles k1, k2, shielding effect of the background portion 1a can be increased.

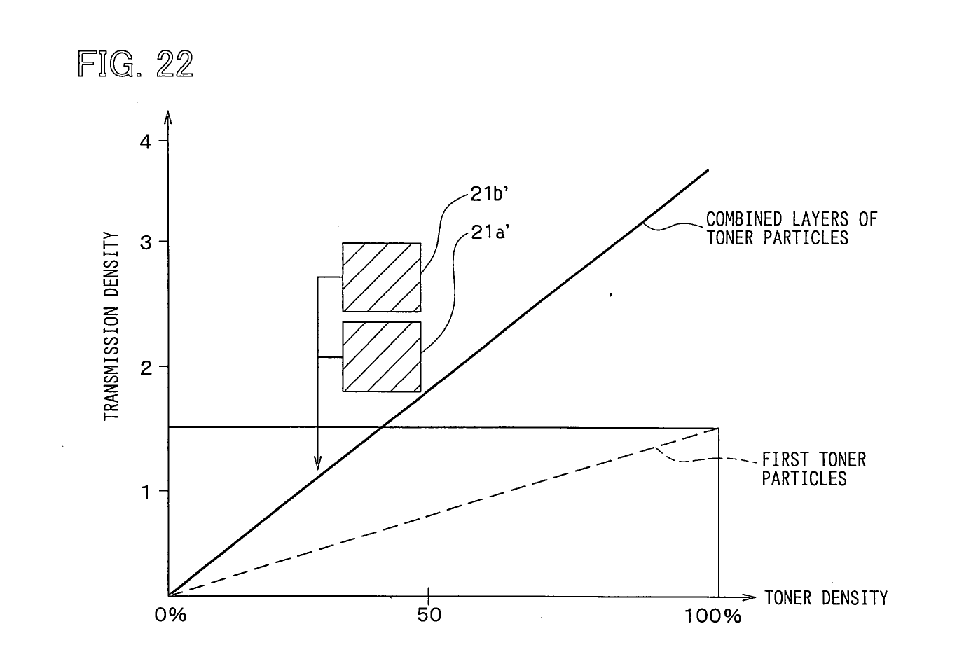

A back light type display panel according to the sixth embodiment is briefly described with reference to FIG. 22.

The gradated background portion 1h is constituted of double layers 21a′, 21b′ of the black toner particles, so that higher transmission density can be provided. As shown in FIG. 22, the transmission density can be increased to about 4. The toner density of the layer 21a′ is approximately the same as the toner density of the layer 21b′.

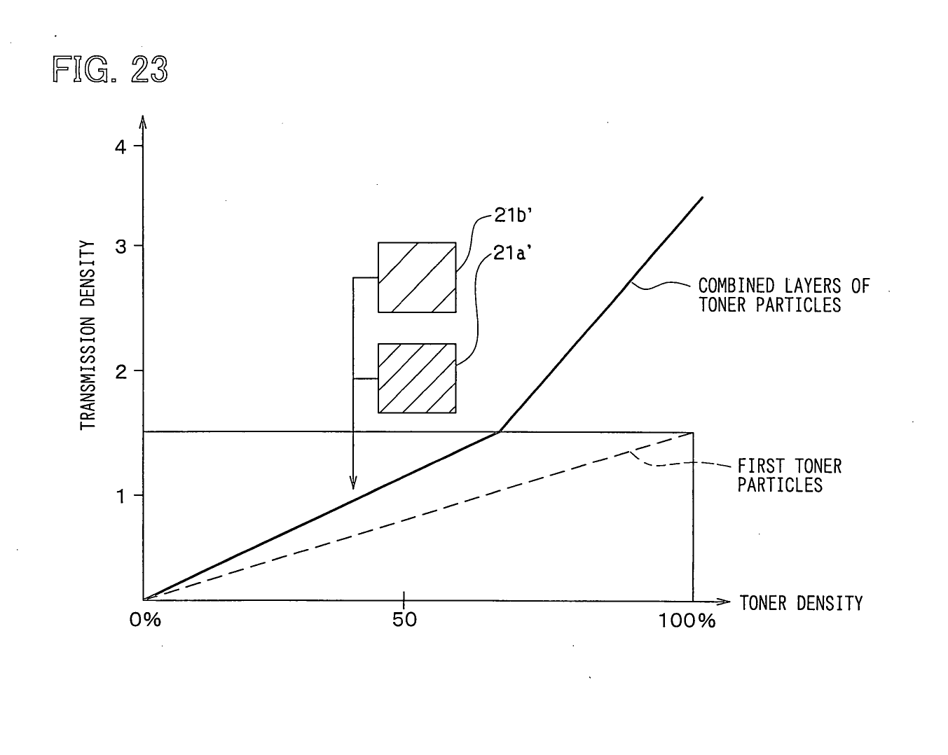

A back light type display panel according to the seventh embodiment is briefly described with reference to FIG. 23.

The gradated background portion 1h is constituted of double layers 21a, 21b of the black toner particles so that higher transmission density can be provided. The ratio of the dotted area per white area of the first and second layers 21a′, 21b′ changes from 0% to 100%. However, the layer 21b′ is added to a portion of the first layer 21a′ at which the ratio of the dotted area is about 30%. Accordingly, the color of the gradated back ground portion 1h gradually changes from blue through deep blue to black.

The transmission density of the first layer 21a′ of this embodiment changes more moderately as the toner density changes than the first layer 21a′ of the fifth embodiment.

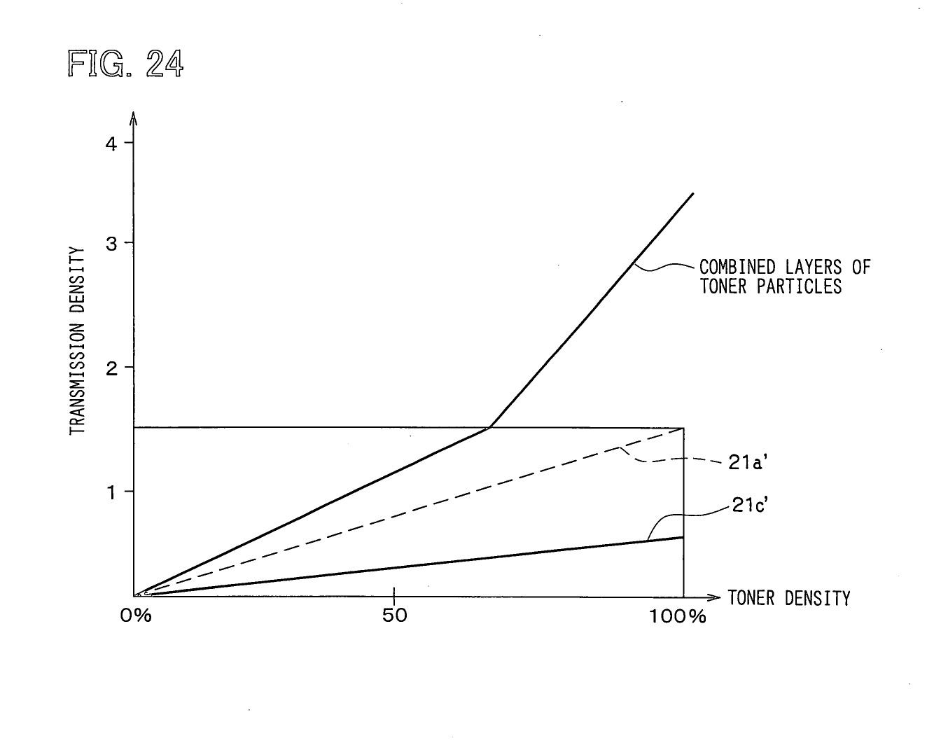

A back light type display panel according to the eighth embodiment is briefly described with reference to FIG. 24.

The gradated background portion 1h is constituted of double layers 21a′, 21b′ of the black toner particles and an additional third layer 21c′ of toners having low transmission density such as white or red toner particles. The ratio of the dotted area per white area of the first, second and third layers 21a′, 21b′, 21c′ changes from 0% to 100%. However, the layers of the black toner particles 21a′, 21b′ are added to a portion of the third layer 21c′ at which the ratio of the dotted area is about 50%. Accordingly, the color of the gradated back ground portion 1h gradually changes from blue through deep blue to black.

The transmission density of the first layer 21a′ of this embodiment changes more moderately and mildly than the fifth or sixth embodiment.

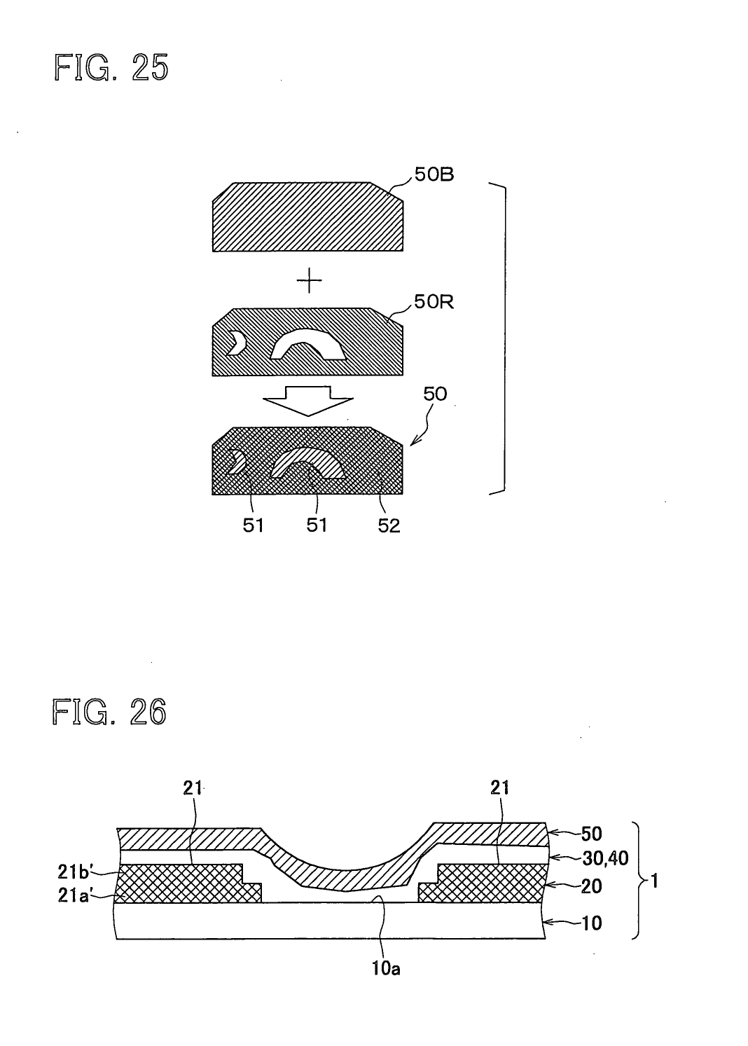

A back light type display panel according to the ninth embodiment is briefly described with reference to FIG. 25.

The layer of ink 50 is constituted of a blue ink layer 50B and a red ink layer 50R so that the combined layers 52 become purple except for portions 51 of blue color. Thus, clean-cut blue color portions 51 without blur can be provided.

A back light type display panel according to the tenth embodiment is briefly described with reference to FIG. 26.

The first layer 21b′ is laid on the second layer so that the peripheral portions thereof provide a slope or a stepped wall, which is effective to form a smooth ink layer.

A back light type display panel according to the eleventh embodiment is briefly described with reference to FIGS. 17A and 17B.

Transparent green and red ink layers 50G, 50R are respectively laid on the layer of the adhesive agent 30 that correspond to areas A1 and A2 surrounded by one-dot chain lines. Because the areas A1, A2 widely surround the transparent printed areas 10a, 10b (or marks 1d, 1g), slight position change of the transparent areas 10a, 10b can be made without design change of a screen of a screen printer.

In the above embodiment, the screen printer can be substituted by another printing means such as an ink-jet type printer, a pad printer or a hot stamping printer. The photoreceptor drums 61K1, 61K2, 61W and 61R of the secondary fixing device can be substituted by separate drums for cyan, magenta, yellow, and black so as to provide full-color printing.

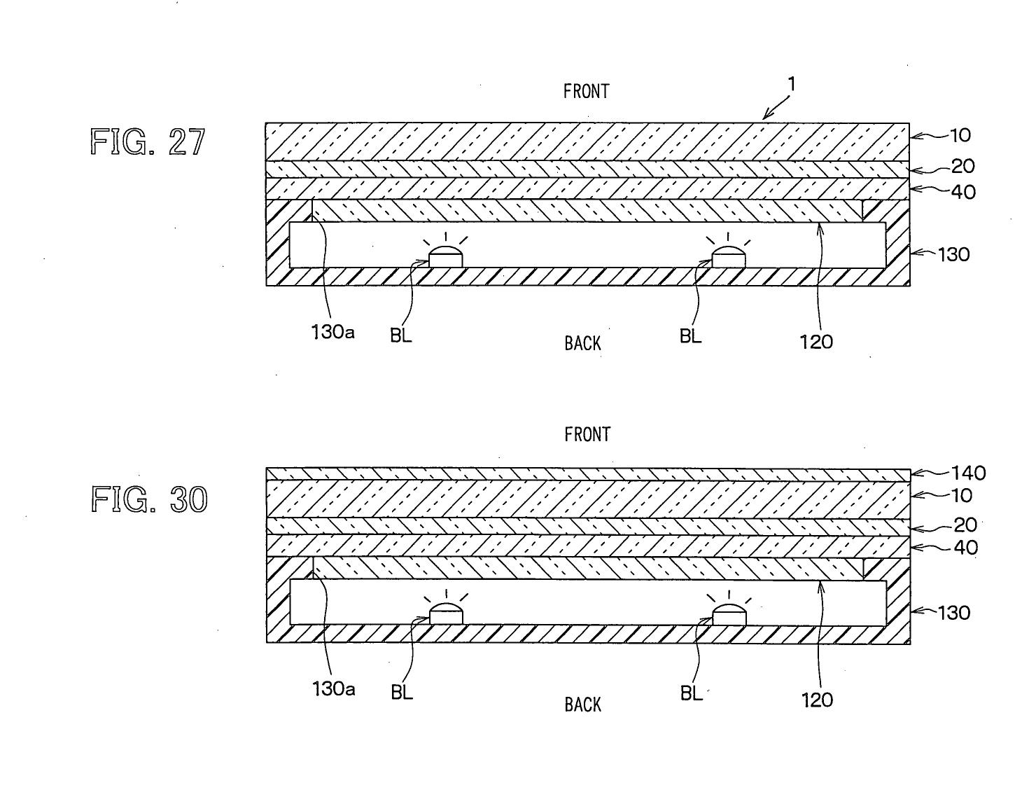

A back light type display panel according to the twelfth embodiment is described with reference to FIGS. 27, 28 and 29. FIG. 27 is a cross sectional view of a portion of an indicating instrument that corresponds to the display section 2 shown in FIG. 1.

The protecting film 40 is made of an ultraviolet curing epoxy resin, such as cationic polymer, whose hardening shrinkage degree of volume is less than 5%.

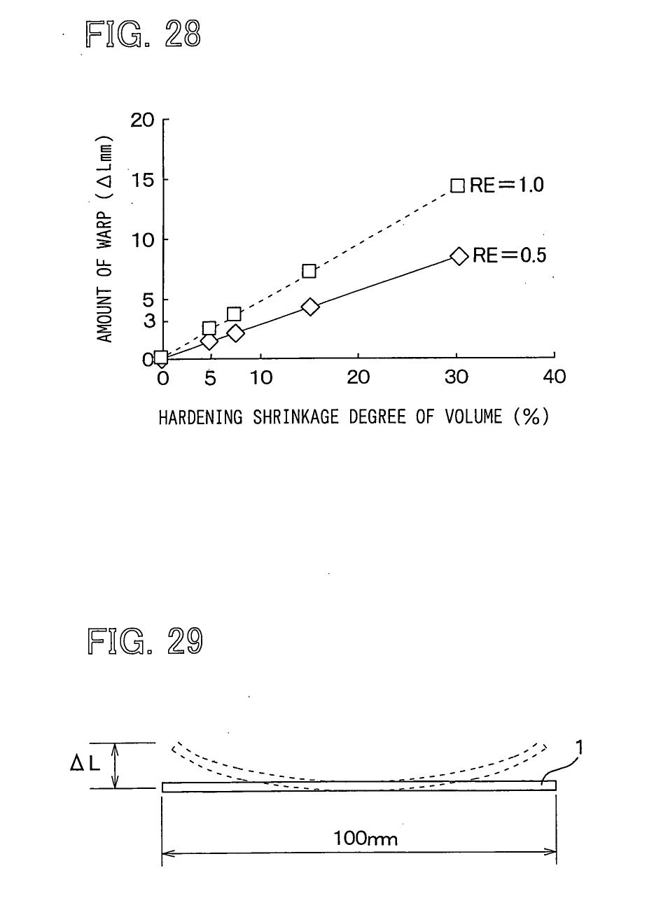

According to a test result, an amount of warp AL of the display panel can be controlled to be less than 3 mm even though the degree of elasticity RE of the protecting film 40 changes from 0.5 to 1.0 if the hardening shrinkage degree of volume of the curing epoxy resin is less than 5%, as shown in FIGS. 28 and 29.

The protecting film 40 is constituted of ink of the ultraviolet curing epoxy resin and beads or fillers of acrylic resin or polyurethane. An average diameter of the bead or the filler is between 2 μm and 50 μm and is larger than the thickness of the protecting film 40. Accordingly, the protecting film 40 has a fine uneven back surface. The protecting film 40 is formed on and fixed to the base film 10 after a mixture layer of the ink and fillers or beads is printed on the base film 10 by a screen printer. The thickness of the protecting film 40 is about 25 μm, however the thickness is good if it is between 5 μm and 100 um.

A disk like light conductive plate 120, which is made of an acrylic resin or polycarbonate resin, is fitted to an opening 130a of a casing 130. The light conductive plate 120 and the display panel 1 is fastened to each other by a plurality of bolts or pins so as to cover the area that corresponds to the display section 2.

The casing 130 has a printed circuit board (not shown) to which a plurality of back-light lamps BL are connected and fixed.

The back-light lamps BL are disposed at the back of the light conductive plate so that the light thereof passes through the display panel 1 in the direction from the back to the front thereof. The light conductive plate 120 is arranged to have a light scattering function to equally conduct the light to all over the display panel 1.

Because the protecting film 40 is made of ultraviolet curing epoxy resin, the protecting film 40 can be formed without heat, so that the layer 20 of the toner particles can be prevented from heat-shrinking. As a result, the display panel 1 can be made flat. The combination of the protecting film 40 that is made of epoxy resin or polycarbonate resin and the light conductive plate 120 that is made of acrylic resin provides a tuck-free connection between the protecting film 40 and the conductive plate 130. Because the light conductive plate 120 has point contacts with the beads or fillers, contact area of the light conductive plate 120 with the protecting film 40 can be reduced, so that the tuck-free connection can be further ensured.

A back light type display panel according to the thirteenth embodiment is described with reference to FIG. 30.

A luster controlling layer 140 is printed on the base film 10 by a screen printer if the layer is formed of ink, or by a electrophotographic device if the layer is formed of toner particles. The light conductive plate 40 may be made of polycarbonate resin instead of epoxy resin if the protecting film 40 is made of acrylic resin.

In the foregoing description of the present invention, the invention has been disclosed with reference to specific embodiments thereof. It will, however, be evident that various modifications and changes may be made to the specific embodiments of the present invention without departing from the scope of the invention as set forth in the appended claims. Accordingly, the description of the present invention is to be regarded in an illustrative, rather than a restrictive, sense.

What is claimed is:

1. A method of manufacturing a back light type display panel comprising:
a first step of forming on a transparent base film an opaque area of a thick layer of toner particles and a transparent area of a thin layer of toner particles;
a second step of covering the opaque and transparent areas of the base film with a transparent protection film on which a thermoplastic adhesive agent is coated to form a laminate member of thick and thin layers of toner, the adhesive agent and the protection film;
a third step of vacuuming the laminate member and its surrounding;
a fourth step of heating the laminate member to be lower for the toner to melt and sufficiently high for the adhesive agent to have a characteristic of tack and pressing opposite surfaces of the laminate member at a first pressure by a pair of pressing boards; and
a fifth step of heating the laminate member to be sufficiently high for the toner to melt, thereby fixing the toner to the base film.

2. A method of manufacturing a back light type display panel comprising:
a first step of forming on a transparent base film anopaque printed area of a thick layer of toner particles;
a second step of covering the opaque printed area with a transparent protection film on which a thermoplastic adhesive agent is coated to form a laminate member of the base film, thick and thin layers of toner, the adhesive agent and the protection film;
a third step of vacuuming the laminate member and its surrounding;
a fourth step of heating the laminate member to be lower for the toner particles to melt and sufficiently high for the adhesive agent to have a characteristic of tack or quick stick; and
a fifth step of heating the laminate member to be sufficiently high for the toner particles to melt, thereby fixing the toner to the base film.

3. The method as claimed in claim 1,
wherein said fourth step comprises a step of heating a pressing board to heat the laminate member.

4. The method of manufacturing as claimed in claim 1,
wherein said fifth step comprises a step of heating the pressing boards to heat the laminate member.

5. The method of manufacturing as claimed in claim 4,
wherein said fifth step comprises a step of heating the pair of pressing boards while pressing the laminate member at a second pressure.

6. The method as claimed in claim 1,
wherein said fifth step further comprises a step of carrying the laminate member to a heating chamber and a step of blowing heated air over it.

7. The method as claimed in claim 1,
wherein said third step comprises a step of inserting the laminate member between the pair of pressing boards, a step of forming a hermetic space by the pressing boards and a step of evacuating air from the hermetic space for vacuuming.

8. The method as claimed in claim 7,
wherein said step of evacuating air is carried out while the laminate member is inserted between the pair of pressing boards.

9. The method as claimed in claim 1,
wherein said step of forming the opaque printed area comprises a step of forming a first layer of the toner particles on the base film and a step of forming a second layer of the toner particles on the first layer of the toner.

10. The method as claimed in claim 9,
wherein the second layer of the toner particles is formed so that the periphery thereof can be located within the periphery of the first layer of the toner particles.

11. The method as claimed in claim 1,
wherein the radius of corners of the opaque printed area adjacent to the transparent printed area is larger than 0.3 mm.

12. A back light type display panel comprising:
a transparent base film;
an opaque layer of printed toner particles printed on said base film;
a transparent layer of ink printed on said base film;
wherein the opaque layer of printed toner particles and the transparent layer of printed ink are disposed in planes in parallel with said base film to form a display pattern that can be seen through the transparent base film from one side of the base film when the display pattern is illuminated from the other side thereof, and
wherein the transparent display pattern is defined by a border line between the layer of the toner particles and the layer of the ink.

13. A back light type display panel comprising:
a transparent base film;
a transparent layer of printed toner particles printed on said base film so that transmission density thereof gradually changes;
a transparent layer of color ink printed on said base film;
wherein said transparent layer of printed toner particles and the transparent layer of printed color ink are overlapped in a line of vision to form a mixed color display pattern that can be seen through the transparent base film from one side of the base film when the display pattern is illuminated from the other side thereof.

14. The back light type display panel as claimed in claim 13,
wherein said transparent layer of toner particles includes a higher perceptive area and a lower perceptive area in transmission density, and
wherein the higher perceptive area is made larger than the lower perceptive area.

15. The back light type display panel as claimed in claim 13,
wherein said opaque layer of toner particles comprises two layers of the first and the second toner particles.

16. The back light type display panel as claimed in claim 15,
wherein said two layers of the first and second toner particles are different in toner density from each other.

17. The back light type indicator as claimed in claim 15,
wherein said first toner particles are black and said second toner particles are one of white color and red color.

18. The back light type indicator as claimed in claim 12, further comprising a transparent protection film coated on said base film,
wherein said transparent layer of printed ink is printed on said protection film on the side thereof far from said base film.

19. The back light type display panel as claimed in claim 18, said transparent layer of printed ink is constituted of a plurality of color ink layers.

20. The back light type display panel as claimed in claim 12,
wherein said transparent layer of ink includes at least one of a direction indicator, a display section for alarming, a scale mark and a letter.

21. The back light type display panel as claimed in claim 12, said transparent layer of printed comprises a plurality of blue ink layers to form a color mixture.

22. The back light type display panel as claimed in claim 12,
wherein said opaque printed area is formed so that periphery of the layer of toner particles have a gradually inclining slope.

23. A back light type display panel comprising:
a transparent base film;
a layer of printed toner particles printed on a rear surface of said base film;
a transparent protecting film covering said transparent layer of printed toner particles; and
a light conductive plate disposed on a surface of said transparent protecting film away from said layer of printed toner particles;
wherein said protecting film is made of ultraviolet curing epoxy resin whose hardening shrinkage degree of volume is less than 5%, and said light conductive plate is made of one of polycarbonate resin and acrylic resin.

24. The back light type display panel as claimed in claim 23,
wherein said ultraviolet curing epoxy resin is made of cationic polymer.

25. The back light type display panel as claimed in claim 23,
wherein said protecting film includes at least one of beads and fillers as a mixture.

26. The back light display panel as claimed in claim 23, further comprising a luster controlling layer disposed on said base film.
